(19) United States
(12) Patent Application Publication
(10) Pub. No.: US 2009/0103587 A1
(43) Pub. Date: Apr. 23, 2009

(54) MONITORING APPARATUS AND CORRESPONDING METHOD

(76) Inventors: Anthony A. Cooper, Crestwood, KY (US); Jerrod Aaron Kappler, Louisville, KY (US); Joshua Paul Kopecky, Louisville, KY (US)

Correspondence Address: General Electric Company;GE Global Patent Operation, PO Box 861, 2 Corporate Drive, Suite 648, Shelton, CT, 06484, US

(21) Appl. No.: 11/876,345

(22) Filed: Oct. 22, 2007

(51) Int. Cl. G01N 25/00

(52) U.S. Cl. 374/45; 374/103

(57) ABSTRACT

A monitoring apparatus configured to monitor a temperature related condition of a compartment of a refrigerator which is cooled by a cooling system. The monitoring apparatus includes a sensor configured to sense a temperature of the compartment when the cooling system is not operating. A processor is configured to send processed information based on the sensed temperature. An indicator is configured to receive the processed information from the processor and to indicate, when the cooling system recommences operation, (i) a duration that the cooling system was not operating and (ii) a temperature of the compartment when the cooling system was not operating.

### BACKGROUND OF THE INVENTION

The described technology relates to a monitoring apparatus, such as a monitoring apparatus for a refrigerator, and a corresponding method.

It is known to provide a refrigerator with freezer and fresh food compartments insulated with insulation. The insulation decreases an amount of energy required to maintain the freezer and fresh food compartments at or below a desired temperature. The insulation also prevents the compartments from absorbing an excessive amount of heat when the compartments are not actively being cooled for a limited period of time, such as when a cooling system of the refrigerator is not operating because of a power outage.

During an extended power outage, however, the freezer and/or fresh food compartments absorb an excessive amount of heat. This absorption of heat results in spoilage of foodstuffs, beverages, medications and/or other items stored in the compartments. After power is restored, the freezer and fresh food compartments are cooled by operation of the cooling system. A user of the refrigerator, who is not aware of the extended power outage, has no indication that the items stored in the refrigerator are spoiled. This lack of awareness may result in severe consequences caused by consumption of spoiled foodstuffs, consumption of spoiled medications, and/or lack of access to unspoiled medications.

### BRIEF DESCRIPTION OF EMBODIMENTS OF THE INVENTION

As described herein, embodiments of the invention overcome one or more of the above-discussed or other disadvantages.

Embodiments of the invention provide a monitoring apparatus configured to monitor a temperature related condition of a compartment of a refrigerator which is cooled by a cooling system. The monitoring apparatus includes a sensor configured to sense a temperature of the compartment when the cooling system is not operating. A processor is configured to send processed information based on the sensed temperature. An indicator is configured to receive the processed information from the processor and to indicate, when the cooling system recommences operation, (i) a duration that the cooling system was not operating and (ii) a temperature of the compartment when the cooling system was not operating.

Further embodiments of the invention provide a method of monitoring a temperature related condition of a compartment of a refrigerator which is cooled by a cooling system. The method includes determining when the cooling system is not actively cooling the compartment, and indicating, when the cooling system recommences active cooling of the compartment, at least one of (i) a temperature of the compartment when the cooling system is not actively cooling the compartment and (ii) a duration of a time period during which the cooling system is not actively cooling the compartment.

### BRIEF DESCRIPTION OF THE DRAWINGS

The following figures illustrate examples of embodiments of the invention. The figures are described in detail below.

FIG. 1 is an isometric view of a side-by-side refrigerator including a monitoring apparatus in accordance with embodiments of the invention.

FIG. 2 is a schematic view of the monitoring apparatus of FIG. 1.

### DETAILED DESCRIPTION OF EMBODIMENTS OF THE INVENTION

Embodiments of the invention are described below, with reference to the figures. In the figures, like reference numbers indicate the same or similar components.

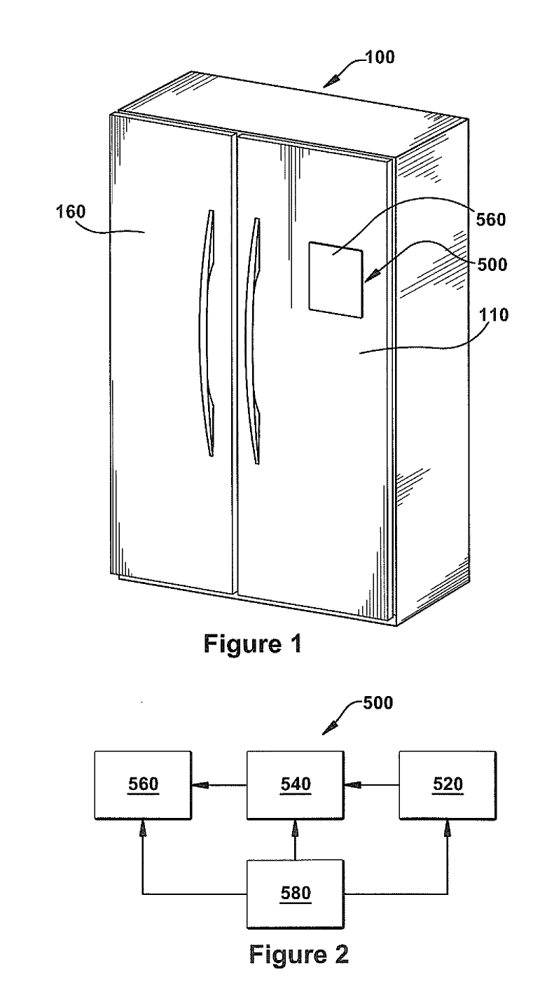

FIG. 1 is an isometric view of a side-by-side refrigerator including a monitoring apparatus in accordance with embodiments of the invention, while FIG. 2 is a schematic view of the monitoring apparatus of FIG. 1.

As shown in the figures, a side-by-side refrigerator 100 includes a fresh food compartment 110 and a freezer compartment 160. The fresh food compartment 110 is configured to store foodstuffs, beverages, medications and/or other items at a temperature greater than a freezing point temperature of water, in a known manner. The freezer compartment 160 is configured to store foodstuffs, beverages, medications and/or other items at a temperature less than the freezing point temperature of water, also in a known manner. The side-by-side refrigerator 100 includes a monitoring apparatus 500 that is configured to monitor and indicate a temperature related condition of one or both of the compartments of the refrigerator 100, as discussed in further detail below.

Although the figures show the monitoring apparatus 500 used with the side-by-side refrigerator 100, the monitoring apparatus 500 is not limited to use with the side-by-side refrigerator 100. By way of specific non-limiting examples, the monitoring apparatus 500 can be used with another type of refrigerator (e.g., a bottom freezer refrigerator, a top freezer refrigerator, a refrigerator that does not include a freezer compartment, or a refrigerator that does not include a fresh food compartment such as a chest freezer or an upright freezer). Alternately, the monitoring apparatus 500 can be used with another appliance that is not a refrigerator and does not include a fresh food compartment or a freezer compartment.

As shown in the figures, the monitoring apparatus 500 includes a sensor 520, a processor 540, an indicator 560 and a power source 580.

In embodiments of the invention, the sensor 520 is configured to sense a temperature of one or both of the fresh food compartment 110 and the freezer compartment 160. In the event that monitoring and indicating of each of the fresh food and freezer compartments 110 and 160 is desired, the sensor 520 can include a first sensor configured to sense the temperature in the fresh food compartment 110 and a second sensor configured to sense the temperature in the freezer compartment 160. Non-limiting examples of the sensor 520 include a thermocouple and a thermistor, the use of each of which is well known to those of ordinary skill in the art.

The processor 540 is configured to receive the temperature sent from the sensor 520, such as under a predetermined condition, and to process the temperature received from the sensor 520 into processed temperature related information. The processor 540 is configured to send the processed temperature related information to the indicator 560, such that the indicator 560 can provide an indication corresponding to, or based on, the temperature related information received from the sensor 520. A non-limiting example of the predetermined condition under which the processor 540 is configured to receive temperature related information includes when a cooling system of the side-by-side refrigerator 100, which cools the fresh food compartment 110 and/or the freezer compartment 160, is not operating. The cooling system may not be operating because of a power outage or because of a malfunction of the cooling system or another system within the side-by-side refrigerator 100. A non-limiting example of the processor 540 is a microprocessor.

The processor 540, or another processor, with or without the use of one or more sensors, can be configured to determine when the predetermined condition occurs (e.g., when the power outage is occurring).

The indicator 560 is configured to provide the indication corresponding to or based on the temperature related condition of the one or both of the fresh food compartment 110 and the freezer compartment 160, based on the processed temperature related information sent from the processor 540. Thus, the indicator 560 is configured to provide the indication corresponding to or based on the temperature related information received from the sensor 520.

In embodiments, the indicator 560 can be configured to provide one or more of the following indications:
a maximum temperature of one or both of the fresh food compartment 110 and the freezer compartment 160 under the predetermined condition;
a current temperature of one or both of the fresh food compartment 110 and the freezer compartment 160 under the predetermined condition;
a duration of time during which a temperature of one or both of the fresh food compartment 110 and the freezer compartment 160 was equal to and/or greater than a predetermined maximum temperature, under the predetermined condition;
a duration of time during which one or both of the fresh food compartment 110 and the freezer compartment 160 was not actively being cooled, under the predetermined condition; and/or
whether one or both of the fresh food compartment 110 and the freezer compartment 160 is currently not actively being cooled.

In embodiments of the invention, the indicator 560 does not display status and/or temperature related information for the compartments 110 and/or 160 when the compartments 110 and/or 160 are not being actively cooled (i.e., the indicator 560 does not provide any indication during the power outage).

In other specific embodiments of the invention, the indicator continuously or intermittently displays (such as when a switch is actuated) a current temperature of the compartment 110 and/or 160 when the cooling system is not actively cooling the compartment 110 and/or 160.

The indicator 560 can be a visual indicator. Non-limiting examples of the indicator 560 include one or more light emitting diodes (LEDs) and/or a liquid crystal display (LCD) screen. The indicator 560 can alternately include an electronic paper display, available from E Ink Corp., of Cambridge, Mass., which is an electronic display that possess a paper-like high contrast appearance, ultra-low power consumption, and a thin, light form.

In embodiments of the invention, the indicator 560 provides a numeric indication of a temperature within the compartment 110 and/or 160. However, the indicator 560 can provide other indicators, including different colored indications (e.g., a green indication when the temperature is within a first predetermined range, a yellow indication when the temperature is within a second predetermined range, a red indication when the temperature exceeds a predetermined limit, etc.).

The power source 580 is configured to provide power to one or more of the sensor 520, the processor 540 and the indicator 560, such as under the predetermined condition. By this arrangement, even if power is not actively being supplied to other components of the side-by-side refrigerator 100, such as because of the power outage or the malfunction of the cooling system, the monitoring apparatus 500 is able to monitor and indicate the temperature related condition of the at least one of the compartments of the refrigerator 100. Non-limiting examples of the power source 580 include one or more batteries, including a non-rechargeable battery that is insertable and/or removable by a user and/or a technician, a rechargeable battery that is recharged during operation of at least one component of the side-by-side refrigerator 100, and/or a capacitor that stores energy during operation of at least one component of the side-by-side refrigerator 100.

The monitoring apparatus 500 can be configured with a bi-metal that is disposed such that when a temperature within the compartment 110 and/or 160 exceeds a certain threshold, a circuit is closed, and power is provided by the capacitor or battery to the indicator 560, which may be a red LED, for example.

Based on the foregoing description, is it understood that the monitoring apparatus 500 can monitor and indicate one or more of a variety of temperature related conditions of one or both of the fresh food compartment 110 and the freezer compartment 160 of the side-by-side refrigerator 100. By way of specific non-limiting examples, the monitoring apparatus 500 can indicate when active cooling of the compartment ceased and recommenced (by indicating a duration of a lack of active cooling (e.g., 25 minutes) and/or a clock time when active cooling ceased and a clock time when active cooling recommenced (e.g., 8:32 AM and 8:57 AM), and can indicate a maximum temperature of the compartment(s) being monitored. In an embodiment of the invention, the monitoring apparatus 500 can further indicate a current temperature of the compartment(s) being monitored.

In another embodiment of the invention, the monitoring apparatus 500 can indicate a relative duration of a time period during which active cooling of the compartment ceased. For example, the monitoring apparatus 500 can provide no indication when the duration of the time period is less than a predetermined time period, and when the duration of the time period is greater than a predetermined time can provide an indication of one or both of (i) when active cooling of the compartment(s) being monitored ceased and recommenced and (ii) a maximum temperature of the compartment(s) being monitored, as discussed above. The monitoring apparatus 500 can also provide, when the duration of time is greater than a second predetermined time, an indication of both of (i) when active cooling of the compartment(s) being monitored ceased and recommenced and (ii) a maximum temperature of the compartment(s) being monitored, as discussed above. By way of a specific non-limiting example, a short-term power loss (i.e., a power loss of a duration less than a predetermined time period) can result in the monitoring apparatus 500 providing no indication of a power loss or an indication that the power loss was of a short-term nature, a medium-term power loss (i.e., a power loss of a duration greater than the predetermined time period and of a duration less than a second predetermined time period) can result in the monitoring apparatus 500 providing an indication of the power loss and a maximum temperature of the compartment(s) being monitored upon power restoration/a temperature of the compartment(s) being monitored upon power restoration, and a long-term power loss (i.e., a power loss of a duration greater than the second predetermined time period) can result in the monitoring apparatus 500 providing an indication that the power loss was of a long-term nature and a maximum temperature of the compartment(s) being monitored upon power restoration/a temperature of the compartment(s) being monitored upon power restoration.

This written description uses examples to disclose embodiments of the invention, including the best mode, and also to enable a person of ordinary skill in the art to make and use embodiments of the invention. It is understood that the patentable scope of embodiments of the invention is defined by the claims, and can include additional components occurring to those skilled in the art. Such other arrangements are understood to be within the scope of the claims.

1. A monitoring apparatus configured to monitor a temperature related condition of a compartment of a refrigerator which is cooled by a cooling system, the monitoring apparatus comprising:
a sensor configured to sense a temperature of the compartment when the cooling system is not operating;
a processor configured to send processed information based on the sensed temperature; and
an indicator configured to receive the processed information from the processor and to indicate, when the cooling system recommences operation, (i) a duration that the cooling system was not operating and (ii) a temperature of the compartment when the cooling system was not operating.

2. The monitoring apparatus according to claim 1, wherein the indicator is configured to indicate the duration that the cooling system was not operating when the cooling system was not operating for a first predetermined time period.

3. The monitoring apparatus according to claim 2, wherein the indicator is configured to indicate when the cooling system was not operating for a second predetermined time period greater than the first predetermined time period.

4. The monitoring apparatus according to claim 3, wherein the indicator is configured to indicate a temperature of the compartment when operation of the cooling system recommenced.

5. The monitoring apparatus according to claim 3, wherein the indicator is configured to indicate a maximum temperature of the compartment when the cooling system was not operating.

6. The monitoring apparatus according to claim 1, wherein the indicator is configured to indicate a maximum temperature of the compartment when the cooling system was not operating

7. The monitoring apparatus according to claim 1, wherein the indicator is configured to indicate a temperature of the compartment when operation of the cooling system recommenced.

8. The monitoring apparatus according to claim 1, wherein the indicator is configured to provide a visual indication.

9. The monitoring apparatus according to claim 8, wherein the indicator comprises a liquid crystal display.

10. The monitoring apparatus according to claim 8, wherein the indicator comprises one or more light emitting diodes.

11. The monitoring apparatus according to claim 8, wherein the indicator comprises an electronic paper display.

12. The monitoring apparatus according to claim 8, further comprising:
a power source configured to provide power to at least one of the sensor, the processor and the indicator when the cooling system is not operating.

13. The monitoring apparatus according to claim 12, wherein the power source is a battery and is configured to provide power to the sensor and the processor.

14. The monitoring apparatus according to claim 12, wherein the power source is a capacitor and is configured to provide power to the sensor and the processor.

15. A method of monitoring a temperature related condition of a compartment of a refrigerator which is cooled by a cooling system, the method comprising:
determining when the cooling system is not actively cooling the compartment; and
indicating, when the cooling system recommences active cooling of the compartment, at least one of (i) a temperature of the compartment when the cooling system is not actively cooling the compartment and (ii) a duration of a time period during which the cooling system is not actively cooling the compartment.

16. The method according to claim 15, wherein indicating comprises indicating both the temperature and the duration.

17. The method according to claim 15, further comprising:
not providing an indication when the cooling system is not actively cooling the compartment for a duration less than a first predetermined duration.

18. The method according to claim 17, further comprising:
providing a predetermined indication when the cooling system is not actively cooling the compartment for a duration greater than a second predetermined duration greater than a first predetermined duration.

19. The method according to claim 18, wherein the first predetermined duration corresponds to a short-term power loss that is of a duration less than a medium-term power loss, and the second predetermined duration corresponds to a long-term power loss greater than the medium-term power loss.

20. The method according to claim 15, wherein indicating the temperature comprises indicating a maximum temperature of the compartment.

21. The method according to claim 15, wherein indicating the temperature comprises indicating a temperature of the compartment when the cooling system recommences cooling of the compartment.

22. The method according to claim 15, further comprising:
continuously or intermittently displaying a current temperature of the compartment when the cooling system is not actively cooling the compartment.
